(19) United States
(12) Patent Application Publication
(10) Pub. No.: US 2026/0079251 A1
(43) Pub. Date: Mar. 19, 2026

(54) SYSTEM AND METHOD FOR RANGING WITH CHANNEL SOUNDING

(71) Applicants: DENSO International America, Inc., Southfield, MI (US); DENSO CORPORATION, Kariya-shi (JP)

(72) Inventors: Mitchell Johnson, Grand Rapids, MI (US); Kyle Cooper, Plainwell, MI (US); Eric J. Smith, Holland, MI (US)

(21) Appl. No.: 18/524,746

(22) Filed: Nov. 30, 2023

Related U.S. Application Data
(60) Provisional application No. 63/496,123, filed on Apr. 14, 2023.

(51) Int. Cl. G01S 13/84; B60R 25/24; G01S 13/82

(52) U.S. Cl. CPC G01S 13/84; B60R 25/245; G01S 13/825

(57) ABSTRACT

A system and method to determine a range between a first device (e.g., an object device) and a second device (e.g., a remote device) based on a characteristic of phase determined with respect to transmissions from a first device to the second device, and optionally a return transmission from the second device back to the first device.

### FIELD OF INVENTION

The present disclosure relates to a system and method for determining a distance between a remote device and an object, such as a vehicle.

### BACKGROUND

Real-time location or position determinations for objects have become increasingly prevalent across a wide spectrum of applications. Real-time locating systems (RTLS) are used and relied on for tracking objects, such as portable or remote devices, in many realms including, for example, automotive, storage, retail, security access for authentication, and security access for authorization.

One conventional RTLS in the automotive realm includes a transmitter located within a vehicle and capable of communicating via radio frequency (RF) with a remote device. In many cases, a signal strength of communications between a transmitter and the remote device is used as a basis for determining a location of the remote device relative to the transmitter or vehicle. For instance, if the signal strength of communications is low, the remote device may be farther away from the vehicle relative to communications where the signal strength is high. In general, the strength of communications drops off as the distance increases between the remote device and the vehicle. The communications between a transmitter and a remote device can be sniffed by sensors disposed on the object. A signal strength of such sniffed communications can be used as a basis for determining a distance between the remote device and each respective sensor. This distance relative to each sensor may allow for a determination of a location of the remote device relative to the object.

The environment and external interference can have a significant effect on accuracy in determining a location or distance based on communications. The environment, for instance, may generate reflections that adversely impact a sensor measurement. RF interference can have a similar adverse effect on the ability to accurately determine location of a remote device relative to an object based on an aspect of communications, such as a signal strength of communications.

### SUMMARY

In general, one innovative aspect of the subject matter described herein can be embodied in a system for determining a distance between a remote device and an object. The system may include a first device disposed in a fixed position relative to the object and including a first antenna system configured to receive and/or transmit a first tone signal from and/or to the remote device. The control system may be configured to determine a first phase characteristic and a second phase characteristic of the first tone signal at a first frequency and a second frequency. The first and second phase characteristics may be indicative of a first phase rotation of the first tone signal between the first device and the remote device. The first control system may be operable to determine a first distance between the first device and the remote based on the first phase rotation of the first tone signal.

The system may include a second device disposed in a fixed position relative to the object. The second device may include a second antenna system configured to monitor the first tone signal between the first device and the remote device. The control system may be configured to determine a second phase rotation of the first tone signal as monitored by the second device. The control system may be configured to determine a second device clock offset between the second device and the remote device based on the first phase rotation and the second phase rotation.

The foregoing and other embodiments can each optionally include one or more of the following features, alone or in combination. In particular, one embodiment includes all the following features in combination.

In some embodiments, the control system may be configured to determine a relative clock offset between the first and second devices based on the second device clock offset.

In some embodiments, the control system may be configured to determine a third phase rotation between the first and second devices without clock ambiguities based on the relative clock offset and an ambiguous phase rotation between the first and second devices determined based on the monitored first tone signal.

In some embodiments, the second device may be configured to receive and/or transmit a second tone signal from and/or to the remote device. The first device may be configured to monitor the second tone signal between the second device and the remote device, and the control system may be configured to determine a third phase rotation of the second tone signal between the second device and the remote device. The control system may be configured to determine a fourth phase rotation between the remote device and the first device based on 1) the second tone signal as monitored by the first device and 2) the second device clock offset between the second device and the remote device.

In some embodiments, the first and second frequency are different.

In some embodiments, the control system may be provided in the first device, and where the first device is operable as an initiator.

In some embodiments, the remote device may be operable as a reflector.

In some embodiments, the control system may be provided as first and second control systems separately disposed in the first and second devices.

In some embodiments, the remote device may be operable as an initiator and the first device may be operable as a reflector.

In some embodiments, the control system may be operable to determine a third phase characteristic of the first tone signal at a third frequency, the third phase characteristic being indicative of the first phase rotation of the first tone signal between the first device and the remote device.

In some embodiments, the first, second, and third frequencies may be different from each other.

In some embodiments, the first tone signal may be an initiator tone signal, and where the first and second phase characteristics may be determined by the remote device with respect to reception of the initiator tone signal from the first device.

In some embodiments, the first tone signal may be a reflector tone signal, and where the first and second phase characteristics may be determined by the first device with respect to reception of the reflector tone signal from the remote device.

In some embodiments, the first phase characteristic of the reflector tone signal may be indicative of a two-way phase rotation of an initiator tone signal and the reflector tone signal at the first frequency, where the second phase characteristic of the reflector tone signal may be indicative of a two-way phase rotation of the initiator tone signal and the reflector tone signal at the second frequency.

In some embodiments, the control system may be operable to determine the first distance based on 1) a difference between the first phase characteristic and the second phase characteristic and 2) a difference between the first and second frequencies.

In some embodiments, the control system may be configured to compensate for motion of the remote device relative to the first device.

In some embodiments, the control system may be configured to subtract an effect of an estimated velocity vector from at least one of the first and second phase rotations.

In some embodiments, the control system may be configured to compensate for multi-phase effects in an environment.

In some embodiments, the control system may be configured to generate a K-space mapping of phase rotations and to identify multi-path artifacts based on the K-space mapping.

In some embodiments, the remote device may be operable as a reflector and the first device is operable as an initiator.

In some embodiments, the second device may be configured to receive and/or transmit a second tone signal from and/or to the first device.

In some embodiments, the control system may be configured to determine a third phase characteristic based on the second tone signal.

In some embodiments, the control system may be configured to repeatedly update the second device clock offset based on the second tone signal.

In general, one innovative aspect of the subject matter described herein can be embodied in a method of determining a location of a remote device relative a first device. The method may include transmitting an initiator signal between the remote device and the first device according to a first frequency, and transmitting the initiator signal between the remote device and the first device according to a second frequency.

The method may include determining a first phase characteristic of the initiator signal at the first frequency and a second phase characteristic of the initiator at the second frequency, where the first and second characteristics may be indicative of a first phase rotation of the initiator signal between the first device and the remote device.

The method may include monitoring, in the second device, the initiator signal between the remote device and the first device, and determining a second phase rotation of the initiator signal as monitored by the second device.

The method may include determining a second device clock offset between the second device and the remote device based on the first phase rotation and the second phase rotation, determining the location of the remote device based at least on the first phase rotation.

The foregoing and other embodiments can each optionally include one or more of the following features, alone or in combination. In particular, one embodiment includes all the following features in combination.

In some embodiments, the method may include determining a relative clock offset between the first and second devices based on the second device clock offset.

In some embodiments, the method may include determining a third phase rotation between the first and second devices without clock ambiguities based on the relative clock offset and an ambiguous phase rotation between the first and second devices determined based on the monitored first tone signal.

In some embodiments, the method may include receiving and/or transmitting, relative to the second device, a second tone signal from and/or to the remote device, and monitoring, in the first device, the second tone signal between the second device and the remote device. The method may include determining a third phase rotation of the second tone signal between the second device and the remote device, and determining a fourth phase rotation between the remote device and the first device based on 1) the second tone signal as monitored by the first device and 2) the second device clock offset between the second device and the remote device.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 shows a system in accordance with one embodiment of the present disclosure.

FIG. 2 shows a system in accordance with one embodiment.

FIG. 3 shows a device of the system in one embodiment.

FIG. 4 shows a portion of the device of the system in accordance with one embodiment.

FIG. 5 shows the system in accordance with one embodiment.

FIG. 6 shows the system in accordance with one embodiment.

FIG. 7 shows a device of the system in accordance with one embodiment.

FIG. 8 depicts communications according to one embodiment.

FIG. 9 shows communications according to one embodiment.

FIG. 10 shows phase wrapping for communications according to one embodiment.

FIG. 11 shows a sniffing arrangement according to one embodiment.

FIG. 12 shows a method of determining a phase rotation according to one embodiment.

FIG. 13 shows a method of determining a phase rotation according to one embodiment.

FIG. 14 depicts a method of phase reconstruction according to one embodiment.

FIG. 15 shows a method of determining a phase characteristic according to one embodiment.

FIG. 16 depicts the timing between two devices during a transmitted and received channel sounding communication according to an embodiment.

FIG. 17 shows a sniffing arrangement with a moving remote device according to one embodiment.

FIG. 18 shows a method of compensating for a moving remote device according to one embodiment.

FIG. 19 shows a method of compensating for multipath artifacts according to one embodiment.

### DETAILED DESCRIPTION

In one embodiment, a system and method are provided to determine a range between a first device (e.g., an object device) and a second device (e.g., a remote device) based on a characteristic of phase determined with respect to transmissions from a first device to the second device, and optionally a return transmission from the second device back to the first device. The transmissions may be transmitted from the first device and may correspond to different frequencies.

A system according to one aspect of the present disclosure may be in compliance with a radio or communications specification (e.g., a Bluetooth specification) to better achieve industry acceptance. A passive channel sounding procedure that involves sniffing may be provided to allow the system sampling rate to increase by a factor commensurate with the number of reflectors (e.g., object-based devices or anchors) in the system. Contemporaneous phase measurements from multiple displaced reflectors may allow the system to include active motion compensation to better resolve the location of the remote device. By not requiring the radios of the reflectors to have coherent phase-locked loop elements, the system 100 can be less complex and likely less expensive than conventional systems that require multiple coherent radios.

The system 100 with sniffing reflectors may enable additional features, use-cases and applications. For example, with a non-moving vehicle, applications may include building a ground-moving target indicator (GMTI) based on the contemporaneous sniffed phase difference that can be used to verify an approaching person is in the same location as the remote device. In another example, the system can be used inside a vehicle to detect movement such as from a child, dog, etc. to indicate the presence for taking actions such as alerting a mobile device or rolling down a window. In another example, with a moving vehicle, the system may assist in a remote park feature.

### I. Location System Overview

A system and method for determining location information of a remote device relative to an object based on a phase-based range is provided. The system and method may determine a location of the remote device based on a phase-based range for first communications between a first object device (e.g., a sensor [also described as an anchor]) and the remote device and a phase-based range for the first communications monitored by a second object device (e.g., a sensor [also described as an anchor]). A clock difference may be determined between the first device and the second device, and the clock difference may form the basis for a phase-based range determination for the first communications monitored by the second object device. The clock difference may be determined repeatedly. The phase-based range may be based on a signal characteristic of communication determined with respect to the first communications, such as a determined phase rotation of the first communications between the remote device and the first object device and a determined phase rotation of the first communications between the remote device and the second object device.

In one aspect, the location of the remote device may be determined based on a phase-based range for second communications between the second object device and the remote device and a phase-based range for the second communications monitored by the first object device.

The object in one embodiment may be mobile, such that its environment may change depending on the location of the object. For instance, in the case of the object being a vehicle, the vehicle may be stored in an enclosed garage with a movable barrier at night, and then driven to and parked in an open-air parking lot, with one or more other vehicles in proximity thereto. The environmental configuration of these locations can vary in significant ways relative to RF or wireless communications, and the environmental configuration may vary in time even when the object is not moving relative to the environment. Such changes in the environment, as well as possible additional factors, may affect a clock difference between the first device on the second device relative to wireless communications. Additional examples of a system with adapting for environmental conditions is described in U.S. Pat. No. 10,869,161, entitled SYSTEM AND METHOD OF DETERMINING REAL-TIME LOCATION, issued Dec. 15, 2020, to Smith.

In one embodiment, a locator may be provided to determine the location information about the remote device relative to the object based on a signal characteristic of communications with the remote device. It should be understood that the present disclosure is not limited to determining the location information based on a single signal characteristic of communications; one or more additional signal characteristics of the communications may be used as a basis by the locator to determine the location information.

The locator, as depicted in FIG. 4, may include a core function 312 operable in conjunction with one or more parameters 314 to determine the location information based on one or more inputs 316, such as at least one signal characteristic of wireless communications, and to generate one or more outputs 318 indicative of a location of the remote device 20 relative to the object 10. The values of the one or more parameters may be selected to yield location information for the remote device relative to the object with a degree of confidence for a given environment. For instance, the locator may be configured to determine the location of the remote device relative to the object in an open-air parking lot with no vehicles in proximity thereto or within 4 inches with a degree of confidence of 90% or better. In one embodiment, selecting the values of the one or more parameters may be based on empirical analysis, including obtaining truth data pertaining to an actual location of the remote device relative to the object along with, for each actual location, at least one sample of at least one signal characteristic. As discussed herein, the system may include a plurality of object devices disposed at different locations on the object, such that a plurality of signal characteristics of the wireless communications can be obtained with respect to different positions on the object. The plurality of signal characteristics may be correlated with truth data pertaining to an actual location of the remote device relative to the object, and one or more parameters in conjunction with the core location function may be trained or selected to yield location information that approximates the truth data within a degree of confidence.

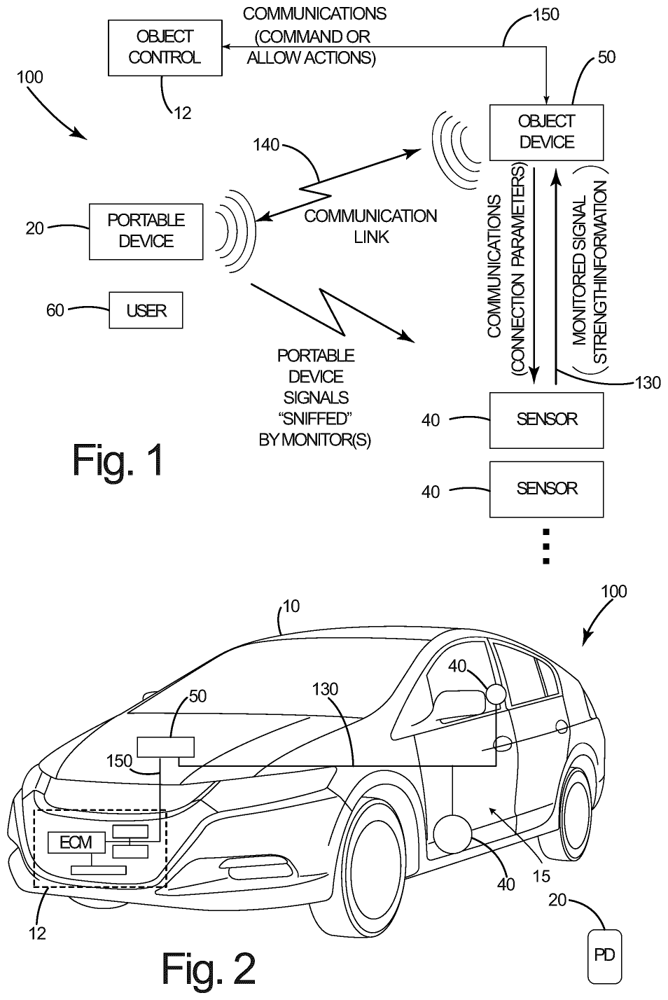

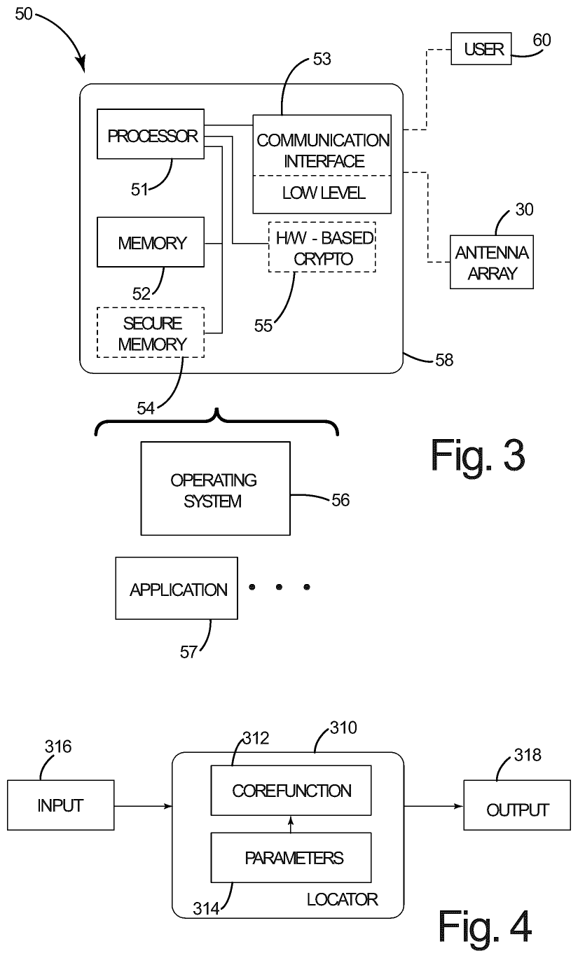

A system in accordance with one embodiment is shown in the illustrated embodiment of FIGS. 1, 2, and 5 and generally designated 100. The system 100 may include one or more system components as outlined herein. A system component may be a user 60 or an electronic system component, which may be the remote device 20, a sensor 40, or an object device 50, or a component including one or more aspects of these devices. The underlying components of the object device 50, as discussed herein, may be configured to operate in conjunction with any one or more of these devices. In this sense, in one embodiment, there may be several aspects or features common among the remote device 20, the sensor 40, and the object device 50. The features described in connection with the object device 50 depicted in FIG. 3 may be incorporated into the remote device 20 or the sensor 40, or both. In one embodiment, the object device 50 may form an equipment component disposed on an object 10, such as a vehicle or a building. The object device 50 may be communicatively coupled to one or more systems of the object 10 to control operation of the object 10, to transmit information to the one or more systems of the object 10, or to receive information from the one or more systems of the object 10, or a combination thereof. For instance, the object 10 may include an object controller 12 configured to control operation of the object 10. The object 10 may include one or more communication networks, wired or wireless, that facilitate communication between the object controller 12 and the object device 50. The communication network for facilitating communications between the object device 50 and the object controller 12 is designated 150 in the illustrated embodiment of FIG. 2 and provided as a CAN bus; however, it is to be understood that the communication network is not so limited. The communication network may be any type of network, including a wired or wireless network, or a combination of two or more types of networks.

In the illustrated embodiment of FIG. 3, the object device 50 may include a control system or controller 58 configured to control operation of the object device 50 in accordance with the one or more functions and algorithms discussed herein, or aspects thereof. The system components, such as the remote device 20 or the sensor 40, or both, may similarly include a controller 58.

The controller 58 may include electrical circuitry and components to carry out the functions and algorithms described herein. Generally speaking, the controller 58 may include one or more microcontrollers, microprocessors, and/or other programmable electronics that are programmed to carry out the functions described herein. The controller 58 may additionally or alternatively include other electronic components that are programmed to carry out the functions described herein, or that support the microcontrollers, microprocessors, and/or other electronics. The other electronic components include, but are not limited to, one or more field programmable gate arrays, systems on a chip, volatile or nonvolatile memory, discrete circuitry, integrated circuits, application specific integrated circuits (ASICs) and/or other hardware, software, or firmware. Such components can be physically configured in any suitable manner, such as by mounting them to one or more circuit boards, or arranging them in other manners, whether combined into a single unit or distributed across multiple units. Such components may be physically distributed in different positions in the object device 50, or they may reside in a common location within the object device 50. When physically distributed, the components may communicate using any suitable serial or parallel communication protocol, such as, but not limited to, CAN, LIN, Vehicle Area Network (VAN), FireWire, I2C, RS-232, RS-485, and Universal Serial Bus (USB).

As described herein, the terms locator, module, model, and generator designate parts of the controller 58. For instance, a model or locator in one embodiment is described as having one or more core functions and one or more parameters that affect output of the one or more core functions. Aspects of the model or locator may be stored in memory of the controller 58, and may also form part of the controller configuration such that the model is part of the controller 58 that is configured to operate to receive and translate one or more inputs and to output one or more outputs. Likewise, a module or a generator are parts of the controller 58 such that the controller 58 is configured to receive an input described in conjunction with a module or generator and provide an output corresponding to an algorithm associated with the module or generator.

The controller 58 of the object device 50 in the illustrated embodiment of FIG. 3 may include one or more processors 51 that execute one or more applications 57 (software and/or includes firmware), one or more memory units 52 (e.g., RAM and/or ROM), and one or more communication interfaces 53, amongst other electronic hardware. The object device 50 may or may not have an operating system 56 that controls access to lower-level devices/electronics via a communication interface 53. The object device 50 may or may not have hardware-based cryptography units 55—in their absence, cryptographic functions may be performed in software. The object device 50 may or may not have (or have access to) secure memory units 54 (e.g., a secure element or a hardware security module (HSM)). Optional components and communication paths are shown in phantom lines in the illustrated embodiment.

The controller 58 in the illustrated embodiment of FIG. 3 is not dependent upon the presence of a secure memory unit 54 in any component. In the optional absence of a secure memory unit 54, data that may otherwise be stored in the secure memory unit 54 (e.g., private and/or secret keys) may be encrypted at rest. Both software-based and hardware-based mitigations may be utilized to substantially prevent access to such data, as well as substantially prevent or detect, or both, overall system component compromise. Examples of such mitigation features include implementing physical obstructions or shields, disabling JTAG and other ports, hardening software interfaces to eliminate attack vectors, using trusted execution environments (e.g., hardware or software, or both), and detecting operating system root access or compromise.

For purposes of disclosure, being secure is generally considered as being confidential (encrypted), authenticated, and integrity-verified. It should be understood, however, that the present disclosure is not so limited, and that the term “secure” may be a subset of these aspects or may include additional aspects related to data security.

The communication interface 53 may be any type of communication link, including any of the types of communication links describe herein, including wired or wireless. The communication interface 53 may facilitate external or internal, or both, communications. For instance, the communication interface 53 may be coupled to or incorporate the antenna array 30. The antenna array 30 may include one or more antennas configured to facilitate wireless communications, including Bluetooth Low Energy (BTLE) communications.

As another example, the communication interface 53 may provide a wireless communication link with another system component in the form of the remote device 20, such as wireless communications according to the Wi-Fi standard. In another example, the communication interface 53 may be configured to communicate with an object controller 12 of a vehicle (e.g., a vehicle component) via a wired link such as a CAN-based wired network that facilitates communication between a plurality of devices. The communication interface 53 in one embodiment may include a display and/or input interface for communicating information to and/or receiving information from the user 60.

In one embodiment, the object device 50 may be configured to communicate with one or more auxiliary devices other than another object device 50 or a user. The auxiliary device may be configured differently from the object device 50—e.g., the auxiliary device may not include a processor 51, and instead, may include at least one direct connection and/or a communication interface for transmission or receipt, or both, of information with the object device 50. For instance, the auxiliary device may be a solenoid that accepts an input from the object device 50, or the auxiliary device may be a sensor (e.g., a proximity sensor) that provides analog and/or digital feedback to the object device 50.

The system 100 in the illustrated embodiment may be configured to determine location information in real-time with respect to the remote device 20. In the illustrated embodiment of FIGS. 1, 2, and 5, the user 60 may carry the remote device 20 (e.g., a smartphone). The system 100 may facilitate locating the remote device 20 with respect to the object 10 (e.g., a vehicle) in real-time with sufficient precision to determine whether the user 60 is located at a position at which access to the object 10 or permission for an object command should be granted.

For instance, in an embodiment where the object 10 is a vehicle, the system 100 may facilitate determining whether the remote device 20 is outside the vehicle but in close proximity, such as within 5 feet, 3 feet, or 2 feet or less, to the driver-side door 15. This determination may form the basis for identifying whether the system 100 should unlock the vehicle. On the other hand, if the system 100 determines the remote device 20 is outside the vehicle and not in close proximity to the driver-side door (e.g., outside the range of 2 feet, 3 feet, or 5 feet), the system 100 may determine to lock the driver-side door. As another example, if the system 100 determines the remote device 20 is in close proximity to the driver-side seat but not in proximity to the passenger seat or the rear seat, the system 100 may determine to enable mobilization of the vehicle. Conversely, if the remote device 20 is determined to be outside close proximity to the driver-side seat, the system 100 may determine to immobilize or maintain immobilization of the vehicle.

The object 10 may include multiple object devices 50 or variant thereof, such as an object device 50 including a sensor 40 coupled to an antenna array 30, in accordance with one or more embodiments described herein.

Micro-location of the remote device 20 may be determined in a variety of ways, such as using information obtained from a global positioning system, one or more signal characteristics of communications from the remote device 20, and one or more sensors (e.g., a proximity sensor, a limit switch, or a visual sensor), or a combination thereof. An example of microlocation techniques for which the system 100 can be configured are disclosed in U.S. Nonprovisional patent application Ser. No. 15/488,136 to Raymond Michael Stitt et al., entitled SYSTEM AND METHOD FOR ESTABLISHING REAL-TIME LOCATION, filed Apr. 14, 2017—the disclosure of which is hereby incorporated by reference in its entirety.

In one embodiment, in the illustrated embodiment of FIGS. 1-5, the object device 50 (e.g., a system control module (SCM)) and a plurality of sensors 40 (coupled to an antenna array 30 as shown in FIG. 3) may be disposed on or in a fixed position relative to the object 10. Example use cases of the object 10 include the vehicle identified in the prior example, or a building for which access is controlled by the object device 50.

The remote device 20 may communicate wirelessly with the object device 50 via a communication link 140. The plurality of sensors 40 may be configured to monitor (e.g., sniff) the communications of the communication link 140 between the remote device 20 and the object device 50 to determine one or more signal characteristics of the communications, such as a phase characteristic, a signal strength, a time of arrival, a time of flight, or an angle of arrival, or a combination thereof. The determined signal characteristics may be communicated or analyzed and then communicated to the object device 50 via a communication link 130 separate from the communication link between the remote devices 20 and the object device 50. Additionally, or alternatively, the remote device 20 may establish a direct communication link with one or more of the sensors 40, and the one or more signal characteristics may be determined based on this direct communication link.

The one or more sensors 40 may be disposed in a variety of positions on the object 10, such as the positions described herein, including for instance, one or more sensors 40 in the door panel and one or more other sensors in the B pillar.

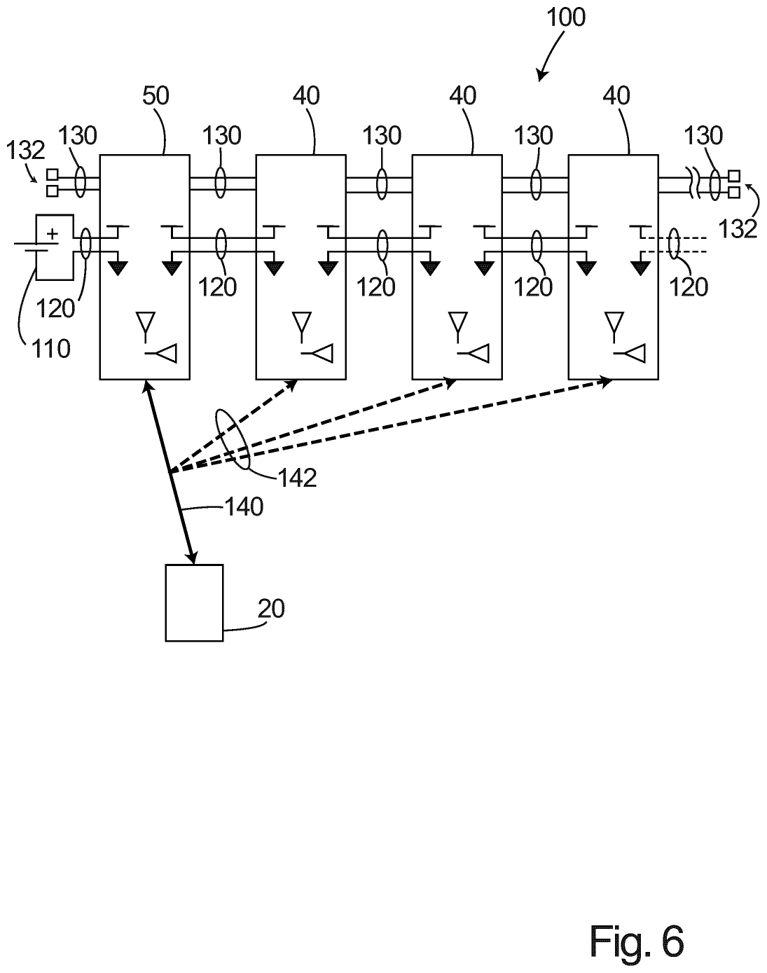

The object device 50 and the one or more sensors 40 may be powered via a power bus 120. The power bus 120 may be daisy chained from one device to the next as depicted in the illustrated embodiment of FIG. 6. Alternatively, the power bus 120 may be provided in the form of a star connection with power being supplied from one location to multiple locations via separate connections. Power supply and associated architecture is not limited to any one type—for instance, power may be distributed via both daisy chain and star connection configurations. The power bus 120 may be coupled to a power supply 110 to facilitate distributing power to devices in the system 100.

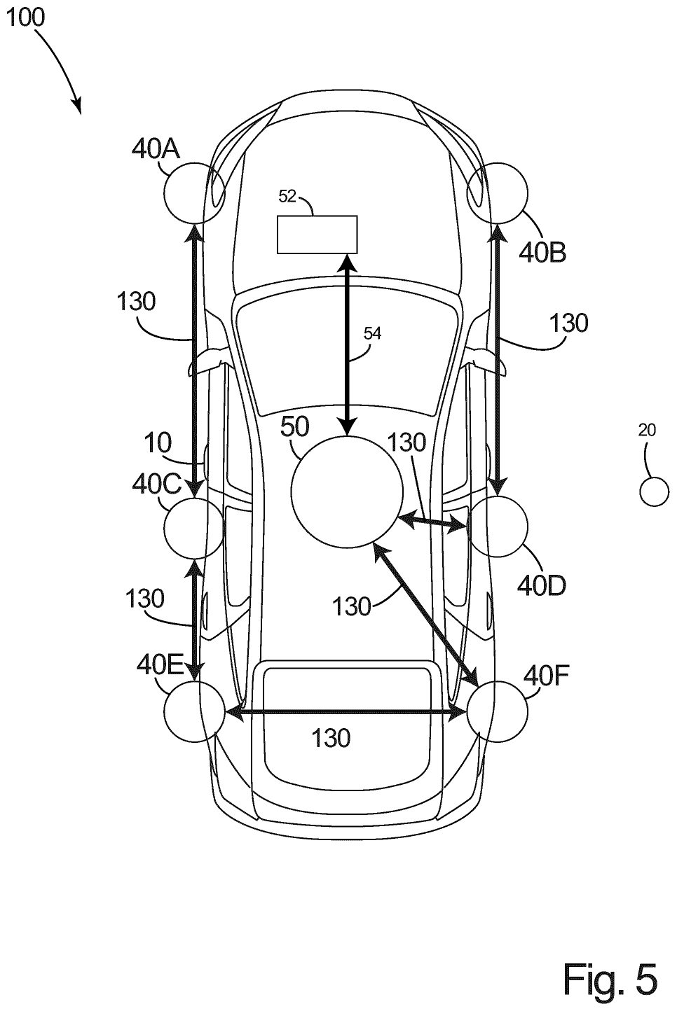

The system 100 in the illustrated embodiment may be configured to determine location information in real-time with respect to the remote device 20. In the illustrated embodiment of FIG. 5, a user may carry the remote device 20 (e.g., a smartphone). The system 100 may facilitate locating the remote device 20 with respect to the object 10 (e.g., a vehicle) in real-time with sufficient precision to determine whether the user is located at a position at which access to the object 10 or permission for an object 10 command should be granted.

In the illustrated embodiment of FIG. 6, the communication link 130 is distributed from one device to another and includes a terminator 132 at each end. The communication link 130 among the devices may be a shared link or a separate link for each device, or a combination thereof. For instance, the communication link 130 may be shared among two or more devices as depicted, and additionally or alternatively, the communication link 130 may be established separately from one device to another device. A device may communicate via more than one separate communications link 130, and may be configured to relay communications from one communication link 130 to another communication link 130.

The remote device 20 may communicate wirelessly with the object device 50 via a communication link 140, such as a BLE communication link or an Ultra-Wideband (UWB) communication link. The plurality of sensors 40 may be configured to monitor (sniff) the communications of the communication link 140 between the remote device 20 and the object device 50 as shown in phantom lines 142. The monitored communications or transmissions may correspond to a tone exchange (one-way or two-way) between the object device 50 and the remote device 20. Based on the monitored communications, a sensor 40 may determine one or more signal characteristics of the communications as described herein, including a phase characteristic of the communications. Additional or alternative signal characteristics include a signal strength, time of arrival, time of flight, angle of arrival, or a combination thereof. The determined signal characteristics may be communicated or analyzed and then communicated to the object device 50 via the communication link 130 separate from the communication link 140 between the remote device 20 and the object device 50.

Additionally, or alternatively, as described herein, the remote device 20 may establish a direct communication link with one or more of the sensors 40, and the one or more signal characteristics may be determined based on this direct communication link. For instance, as described herein, the remote device 20 and a sensor 40 may perform a tone exchange as a basis for determining a distance between the sensor 40 and the remote device 20. The direct communication link may be established according to the BLE protocol; however, the present disclosure is not so limited—the direct communication link may be any type of link or links, including Ultra-Wideband (UWB).

It is to be understood that an object 10, such as a vehicle, may include a number of sensors 40 (A-F) that can be greater than or less than the number shown in the illustrated embodiment of FIGS. 1 and 2. Depending on the implementation, some number of sensors 40 may be integrated in a vehicle.

As described herein, one or more signal characteristics, such as a phase characteristic, a signal strength, time of arrival, time of flight, and angle of arrival, may be analyzed to determine location information about the remote device 20 relative to the object 10, as an aspect of the object 10, or the object device 50, or a combination thereof. For instance, a phase rotation of a tone transmission, and optional re-transmission, or a phase characteristic indicative of a phase rotation may form the basis for determining a distance between an object device 50 or a sensor 40 and the remote device 20. Additional examples of signal characteristics include time difference of arrival or the angle of arrival, or both, among the sensors 40 and the object device 50 may be processed to determine a relative position of the remote device 20. The positions of the one or more antenna arrays 30 relative to the object device 50 may be known so that the relative position of the remote device 20 can be translated to an absolute position with respect to the antenna arrays 30 and the object device 50.

Additional or alternative types of signal characteristics may be obtained to facilitate determining position according to one or more algorithms, including a distance function, trilateration function, a triangulation function, a lateration function, a multilateration function, a fingerprinting function, a differential function, a time of flight function, a time of arrival function, a time difference of arrival function, an angle of departure function, a geometric function, or any combination thereof.

### II. System Device Overview

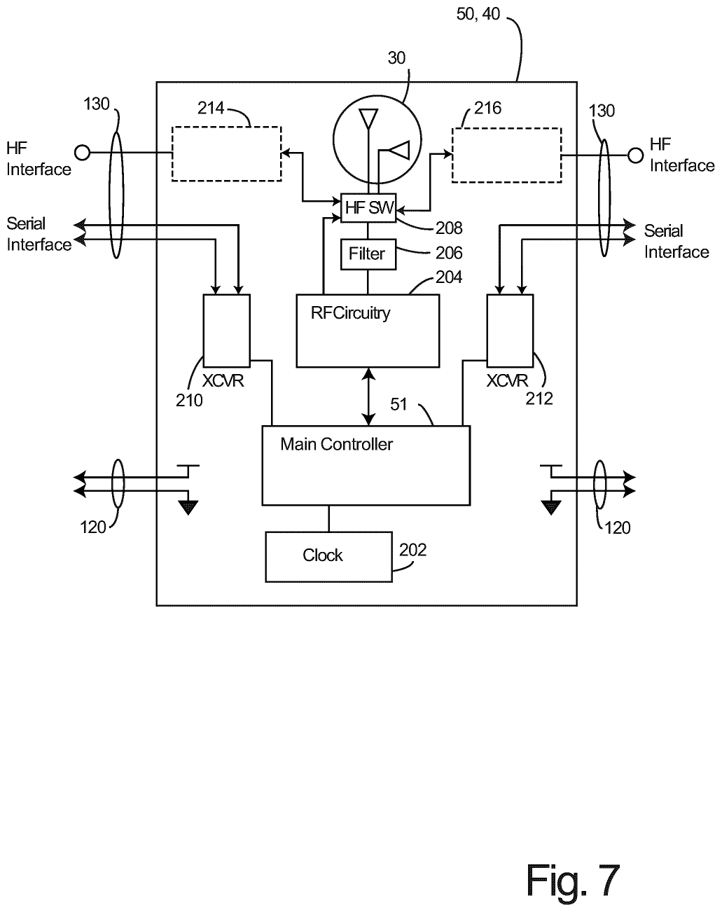

In the illustrated embodiment of FIG. 7, the object device 50 in one aspect is shown in further detail. The structure and configuration of described in conjunction with FIG. 7 may be incorporated into a sensor 40 or an object device 50—but for purposes of disclosure, the structure and configurations described in conjunction with the object device 50.

The object device 50 in the illustrated embodiment of FIG. 7 includes several components, one or more of which may be provided in a commercial embodiment. The object device 50 in some instances may be described as an anchor disposed on the object 10.

The object device 50 may include RF circuitry 204 operable to control transmission and reception of HF signals. The RF circuitry 204 may be operably coupled to an antenna array 30, which may include one or more antennas. An example configuration of an antenna array 30 is described in U.S. Nonprovisional patent application Ser. No. 18/096,666 to Osman Ahmed et al., entitled SYSTEM AND METHOD FOR COMMUNICATING, filed Jan. 13, 2023—the disclosure of which is incorporated herein by reference in its entirety.

The RF circuitry 204 may be configured to supply or receive high-frequency signals from the antenna array 30 via filter circuitry 206 and a HF switch 208. The filter circuitry 206 may condition the signal output from the RF circuitry 204 for driving the antenna array 30. Conversely, the filter circuitry 206 may condition a signal received from the antenna array 30 for processing by the RF circuitry 204. The HF switch 208 may selectively direct input and output of HF signals, including HF supplied to and received from the antenna array 30.

In one embodiment, the RF circuitry 204 may be configured according to one embodiment to transmit and receive signals via a high-frequency interface of the communication link 130. Transmission and reception of HF signals in one embodiment may enable an object device 50 to communicate via a physical medium according to a communication protocol that is the same or similar to the one utilized by the antenna array 30 in the RF circuitry 204. For instance, the object device 50 may transmit and receive communications via a physical medium defined by the high-frequency interface that correspond to the BTLE communications, while also transmitting and receiving communications via the antenna array 30 that correspond to BTLE communications.

The HF switch 208 may selectively direct output from the RF circuitry 204 to the high-frequency interface of the communication link 130, and selectively direct input from the high-frequency interface of the communication link 130 to the RF circuitry 204. In one embodiment, the HF interface may be a single ended configuration, such as a coaxial conductor arrangement. Alternatively, the HF interface may be differential, and optionally include conditioning circuitry 214, 216 (e.g., a balun and/or an impedance transformer) for translating between a single ended output from the HF switch 208 and a differential output of the high-frequency interface of the communication link 130.

In one embodiment, the high frequency switch 208 and the conditioning circuitry 214, 216 may be absent, such that the communication link 130 is provided via a serial interface or another type of communication interface, as described herein.

In the illustrated embodiment, the object device 50 is configured to transmit and receive communications via separate high-frequency interfaces provided by separate communication links 130. In other words, the two communication links 130 in the illustrated embodiment are isolated from each other, such that communications received on one communication link 130 are not inherently transmitted or seen on the other communication link 130. As discussed herein, the object device 50 may be configured to relay communications from one of the communication links 130 to the other of the communication links 130. For example, communications received via one high-frequency interface may be directed to the RF circuitry 204, and may be related to the other high-frequency interface via the RF circuitry 204. The HF switch 208 may be in transition from one state to another state to facilitate relaying of such communications. It is to be understood, however, that in one or more embodiments described herein, communications transmitted via one of the communication links 130 may inherently pass to the other of the communication links 130.

The object device 50 may include a main controller 51 and may be configured to direct operation of the RF circuitry 204, as described herein. In one embodiment, the main controller 51 may control a tone exchange via the antenna array 30 to facilitate determining a one-way range or two-way range determination with respect to the remote device 20. Additionally, or alternatively, the object device 50 may sniff communications that pertain to a tone exchange and that occur between another object device (e.g., a sensor 40) and the remote device 20. In one embodiment, a sensor 40 may be configured to monitor or sniff communications that pertain to a tone exchange and that occur between the object device 50 and the remote device 20.

The main controller 51 may further direct transmission and reception of communications via the HF interface of the one or more communication links 130. As an example, the main controller 51 may direct transmission and reception of BTLE communications via the HF interface of the communication link 130. Information transmitted via the high-frequency interface of the communication links 130 may relate to one or more signal characteristics obtained with respect to communications received and/or transmitted via the antenna array 30. As an example, the information transmitted via the communication link 130 may be indicative of a phase rotation determined with respect to communications received and/or transmitted via the antenna array 30.

Additionally, or alternatively, the main controller 51 may utilize the high-frequency interface of the communication links 130 for time synchronization or time offset determination purposes. As discussed herein, a phase characteristic of a tone exchange is based at least in part on a time reference of the device. And because time is translatable to distance (and conversely distance to time) with respect to electromagnetic waves, determining the reference time of the sensor 40 may facilitate enhancing accuracy with respect to determining the phase characteristic and distance between the remote device 20 and the object device 50.

The object device 50 may include a clock 202 that operates an oscillator for the sensor 40 and generates one or more timing signals for operation of aspects of the object device 50, including the main controller 51 and the RF circuitry 204. In one embodiment, the clock 202 may be configured to generate a timing signal that the main controller 51 and/or the RF circuitry 204 may use as a basis for transmitting a tone exchange signal (e.g., an initiator signal). As described herein, the tone exchange signal may include transmissions according to a plurality of frequencies and a phase rotation with respect to such transmissions and may form the basis for a distance determination with respect to the object device 50 and the remote device 20.

In one embodiment, the object device 50 includes first and second transceivers 210, 212 coupled respectively to serial interfaces of the communication links 130. The transceivers 210, 212 may be CAN transceivers, but the present disclosure is not so limited. The transceivers 210, 212 may facilitate any type of serial or non-serial communications via the communication links 130, including but not limited to RS-485, LIN, Vehicle Area Network (VAN), Fire Wire, I2C, RS-232, RS-485, and Universal Serial Bus (USB).

The first and second transceivers 210, 212 may enable communications among devices (e.g., the object device 50 and a sensor 40). For instance, the object device 50 may transmit to a sensor 40, via the serial interface of the communication link 130, connection parameters for the communication link 140 to enable the sensor 40 to monitor communications between the object device 50 and the remote device 20. A sensor 40 may receive such communications via the first transceiver 210 and relay the communications to another device (e.g., another sensor 40) via the second transceiver 212.

Optionally, the object device 50 may include a communication link 130 configured with a serial interface without the high-frequency interface or a high-frequency interface without the serial interface. Communications described herein with respect to one interface and not the other may be communicated via the interface provided by the communication link 130. For instance, the communication link 130 may include a high-frequency interface without the serial interface, and communications described in connection with the serial interface may be transmitted via the high-frequency interface. The high frequency interface and/or the serial interface may be wired or wireless.

The communication interface of the main controller 51 may facilitate any type of communication link, including any of the types of communication links described herein, including wired or wireless. The communication interface may facilitate external or internal, or both, communications. For instance, the communication interface may be coupled to the RF circuitry 204 to enable communications via one or more of the antenna array 30 and the HF interface of the communication link 130.

As another example, the communication interface of the main controller 51 may facilitate a wireless communication link with another system component in the form of the remote device 20, such as wireless communications according to the Wi-Fi standard or UWB, or any combination thereof. As another example, the communication interface of the main controller 51 may include a display and/or input interface for communicating information to and/or receiving information from the user.

### III. Phase-Based Ranging

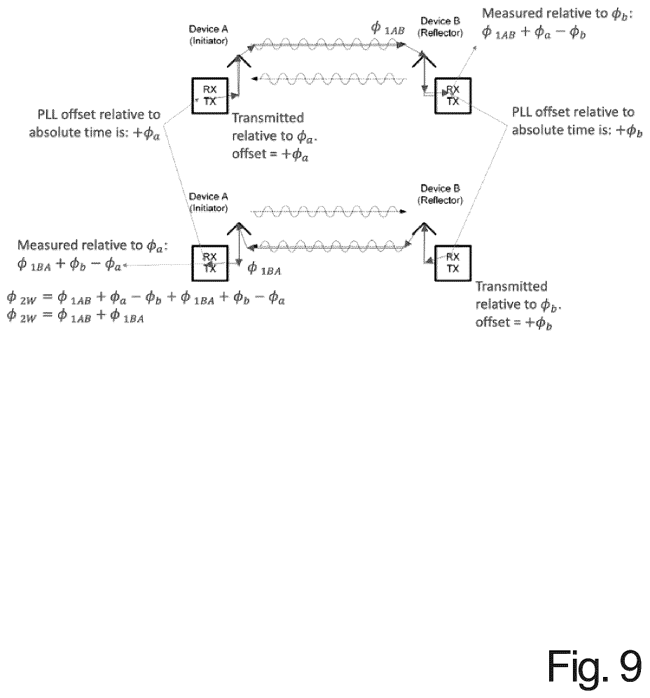

In the illustrated embodiment of FIG. 9, a tone exchange according to a plurality of frequencies f_0, f_1, f_2, f_3 is depicted with the object device 50 being the initiator or device A and the remote device 20 being a reflector or device B. It is noted that device A and/or device B may be different devices in the system 100. For instance, device A may be a sensor 40 and device B may be the remote device 20. As another example, device A may be an object device 50 and device B may be a sensor 40. In using different frequencies for the tone exchange, a type of channel sounding for ranging approach is utilized.

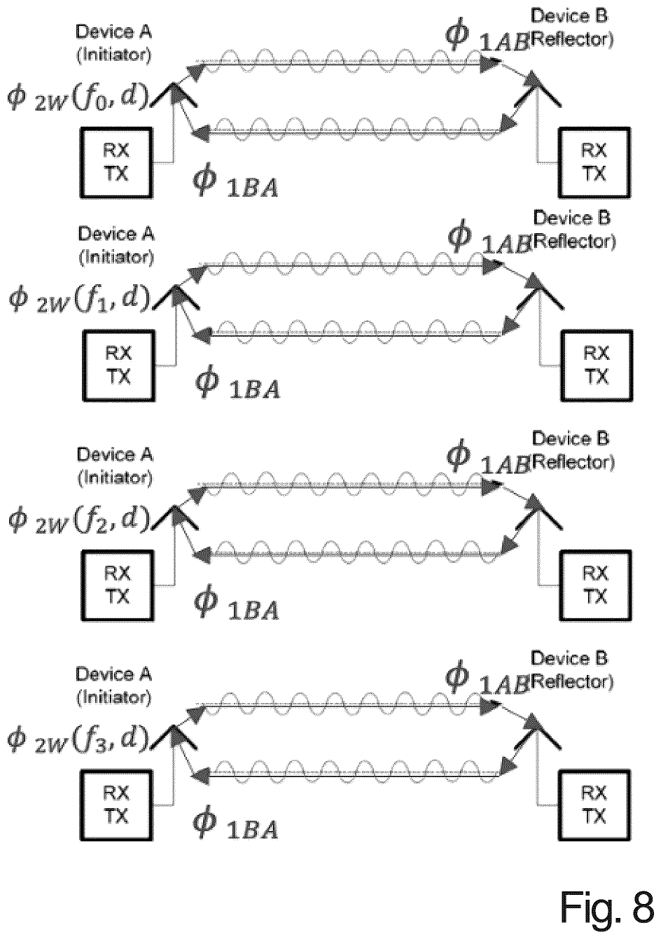

In FIG. 8, the tone exchange may involve device A transmitting an initiator signal according to a frequency, device B receiving the initiator signal, device B transmitting a reflector signal based on the initiator signal according to the same frequency, and device A receiving the reflector signal. Based on a phase characteristic of the initiator signal and/or the reflector signal measured respectively by the device B or device A, a phase rotation of the initiator signal and/or the reflector signal may be determined, enabling a distance determination with respect to device A and B.

A single tone exchange according to frequency f_0 is depicted in further detail in FIG. 9, and discussed in conjunction with one or more phase characteristics and related properties of the tone exchange. For purposes of this example, the frequency f_0 is identified as 2.4 GHz-however the frequency may vary. At this example frequency the wavelength of the signal is approximately 12.5 cm. By knowing the total phase rotation, there and back for the initiator and reflector signal, distance can be determined. For instance, if the total phase of a two-way exchange (φ_AB++φ_BA or φ_2 W) is measured as 90 deg. (¼ of a full rotation), the two-way distance can be determined as 12.5 cm*¼+12.5 cm*N, with N being the number of wraps or full rotations of the initiator and reflector signals.

If the tone exchange is conducted for a second frequency f_1, different from f_0, a different measured phase will result, and the wavelength will be different due to the change in frequency. The difference in measured phase coupled with the known frequency difference (f_1-f_0) may facilitate determining N, the number of wraps or full rotations of the initiator and reflector signals.

In the illustrated embodiment of FIG. 9, there may be an initial phase offset relative to a timing signal. This phase offset of device A as well as the phase offset of device B for a two-way exchange cancel out in determining a two-way phase rotation.

In the illustrated embodiment, the initiator (device A) transmits and receives with a relative phase offset of φa, and the reflector (device B) transmits and receives with a relative phase offset of φb. φa is the inherent phase offset of the initiator, and φb is the inherent phase offset of the reflector. The one-way phase rotation φ1 W=φ1AB, with the phase from A, measured at B, when φa and φb are 0 or the same, and the one-way phase rotation φ1 W=φ1BA, with the phase from A, measured at B, when φa and φb are 0 or the same. However, when the φa and φb are not the same, these offsets cause the measured phase at B and at A to be different. This is because, when going from A to B, φa causes A to transmit late and φb causes B to measure late. φ1ABmeasured=φ1AB+φa−φb, when going from B to A, φb causes B to transmit late and φa causes A to measure late, with φ1BAmeasured=φ1BA+φb−φa. When these are summed together, the two-way rotation can be determined as:

$$ϕ 2 W = ϕ1 AB measured + ϕ1 BA measured = ϕ1 AB + ϕ a - ϕ b + ϕ1 BA + ϕ b - ϕ a$$

It can be seen that φa and φb cancel out. Switching to the Euler notation yields the same result with the phase offsets cancelling when the exponents are combined, such that the two-rotation can be determined as:

$$Φ2 W = {e}^{j \frac{4 π fd}{c}}$$

The notation for determining one-way and two-way rotations can vary depending on documentation parameters and the method utilized for conceptualizing phase. For instance, phase can be described relative to the IQ domain, where I+Qj=X+Yj=Φ=cos(φ)+j sin(φ)=e^{-j}. Here, Φ, capital PHI, is the complex representation of the phase in radians or φ, lowercase phi. The Φ_1AB_measured value may be called the reflector Phase Correction Term (PCT), or PCT_B, while the Φ_1BA_measured value may be called PCT_A. The two-way rotation Φ2 W=Φ1_AB_measured·Φ1_BA_measured.

Because the wavelength for high frequency transmissions can be short relative to the target distance being measured, the transmissions wrap or complete full phase rotations such that total phase rotation embodied as the total distance cannot be measured directly from a phase in the input stage of the RF circuitry 204. For instance, for a carrier frequency at 2.4 GHz, the phase rotation wraps around 2π with d in the range of 12 cm. A phase measurement in the input stage of the RF circuitry 204 may indicate a phase within the range 0-2π, but the phase measurement may not directly indicate the number of phase rotation wraps.

To measure longer distances without ambiguity, two different frequencies (f0, f1) can be used at two different instants i in time (i0, i1) to compute two different phases rotations. The two different phase rotations can be used to measure the distance. A phase-based distance determination is described in conjunction with two different frequencies-however, it is to be understood that phase measurements for a plurality of frequencies (including more than two frequencies) may be used to enhance accuracy of the distance determination.

In the case of utilizing two or more different frequencies (f_0, f_1) as a basis for determining distance, as depicted in FIG. 8, the initiator may conduct two tone exchanges to measure a two-way phase rotation (φ_2w) at the two frequencies (f_0, f_1). In this example, φ_2w (f_0, d)=φ_1AB (f_0, d)+φ_1BA (f_0, d), where the phase characteristic, φ_1AB (f_0, d) is measured in the initiator and the phase characteristic, φ_1BA (f_0, d) is measured in the reflector. And, φ_2w (f_1,d)=φ_1AB (f_1,d)+φ_1BA (f_1, d), where the phase characteristic, φ_1AB (f_1, d) is measured in the initiator and the phase characteristic, φ_1BA (f_1, d) is measured in the reflector. The difference in the two-way phase measurements, φ_2w (f_0, d)-φ_2w (f_0, d), is related to the difference in frequency and distance as follows:

$$Δ {ϕ}_{2 W} = \frac{4 π d Δ f}{c} mod 2 π$$

Based on the difference in the two-way phase measurements, distance and time delay can be determined as follows:

$$d = \frac{c Δ {ϕ}_{2 W}}{4 π Δ f} mod \frac{c}{2 Δ f}$$

$$t = \frac{d}{c} = \frac{{Δϕ}_{2 W}}{4 πΔ f} mod \frac{1}{2 Δ f}$$

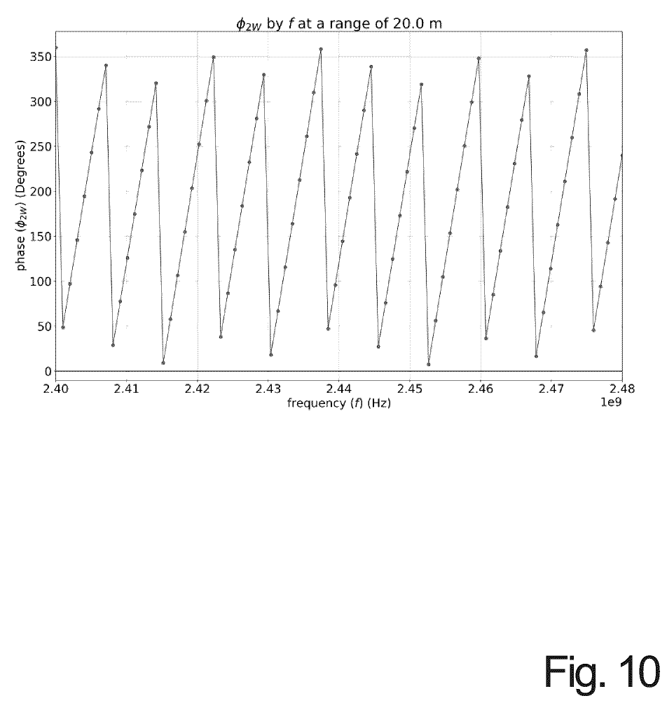

It is noted that from the relationship between two-way phase rotation, frequency, and distance, that the two-way phase rotation (φ_2w) wraps back to 0 with distance remaining constant and changing frequency. As a result, for multiple frequencies in a band (e.g., 2.4 GHz to 2.48 GHz), the two-way phase rotation may wrap back to 0 degrees zero or more times depending on the distance. The wrap distances for round trip or two-way phase rotation and a plurality of frequencies are depicted in the illustrated embodiments of FIG. 10. It can be seen specifically in FIG. 10 that, for a distance of 20 m, a 2.4 GHz to 2.48 GHz signal wraps at 1 MHz frequency steps. The slope of the two-way phase rotation may also depend on the distance. In one embodiment, distance may be determined based at least in part on the slope and/or the frequency at which the two-way phase rotation wraps.

The present disclosure is not limited to determining two-way phase rotation. The one-way phase rotation (φ_1w) may be conceptualized in a similar manner, with the distance and time delay being determined as follows:

$$d = \frac{c Δ {ϕ}_{1 W}}{2 π Δ f} mod \frac{c}{Δ f}$$

$$t = \frac{d}{c} = \frac{{Δϕ}_{1 W}}{2 πΔ f} mod \frac{1}{Δ f}$$

It is noted, however, that in order to obtain an accurate one-way ranging delta between the transmission phase and the reception phase, the initiator and the receiver may need to be synchronized in time. With two-way ranging, lack of synchronicity may not be necessary because differences in time bases for the two devices may cancel out.

### IV. Sniffing/Monitoring and Phase-Based Ranging

As discussed herein, channel sounding can directly calculate distance between a device A and a device B (e.g., a set of radios and a remote device) by measuring a quadrature signal (i.e., the I and Q modulation) between the device A and the device B. A system 100 (e.g., a passive access system) can then be configured to determine a range between the device A and the device B by analysis based primarily on the phase of that modulation over the Bluetooth channels. This arrangement may allow one object-based device (e.g., the object device 50 or the sensor 40) to communicate with the remote device 20 at a time. This arrangement, without a sniffing or monitoring configuration, may be practically limited to the speed at which the system 100 can be run for each ranging procedure between one object-based device and the remote device 20. Each radio of each object-based device may take its own turn communicating with the remote device 20 and, as described herein, the vehicle or object 10 may include five to seven or more radios (e.g., object device 50 and sensors 40). This turn-by-turn approach for communicating between an object device and the remote device 20 can increase the amount of time for the system 100 to determine a location and take an action, such as unlocking a door.

Providing temporal coherence between object-based devices can enable such one object device or sensor to monitor the tone exchange between another object device or sensor and the remote device 20, and to determine a distance without conducting a direct tone exchange with the remote device 20. However, temporal coherence may not be supported by the communication standard underlying the tone exchange (e.g., by the BTLE standard).

In one aspect, all of the object devices 50 and sensors 40 (e.g., all of the radios) of the system 100 maybe capable of measuring a range to a remote device 20 when only one of the devices (e.g., one radio) is in direct communication with the remote device 20. In a further aspect, these radios may not be required to be coherent with one another.

In one aspect, the system 100 may provide selective access to an object 10 (such as a vehicle) where each radio of the system 100 may be configured to alternatively engage in direct communication with the remote device 20 to transmit quadrature modulated radio frequency energy across a set of radio frequency channels, such that the radio (acting as an active reflector) and the remote device 20 (acting as an initiator) each receive phase information from each other, and where the other radios (acting as passive sniffing reflectors) can sniff the channel sounding procedures. By combining the sniffed phase measurements with the local oscillator (LO) difference between initiator and reflector, the system 100 can recover from the reflector's measured phase information, an output that is the difference in phase between the initiator and the active reflector and the sniffing reflector.

In one aspect, a method for performing motion compensation is provided to counteract the effects that movement of the remote device 20 may impart on the measured phase information measured by the active and sniffing reflectors of the system 100. Each of the radios may measure phase information indicative of the range to the remote device 20. A method of motion compensation may include comparing nonlinear shifts in phase differences between the reflectors to determine and/or remove a velocity component in the measured data to improve ranging accuracy estimates.

In one aspect, a method for performing multipath mitigation is provided to counteract the effects that a complex environment may have on the phase information measured by the reflectors of the system 100. The system 100 can be configured to perform a step of synthesizing a sparse two-dimensional aperture based on the contemporaneous phase information measured by the active reflector and the sniffing reflectors. The system 100 can also be configured to perform the steps to reconstruct a synthetic aperture image in and around an object 10 and remove multipath-induced artifacts to better localize the remote device 20.

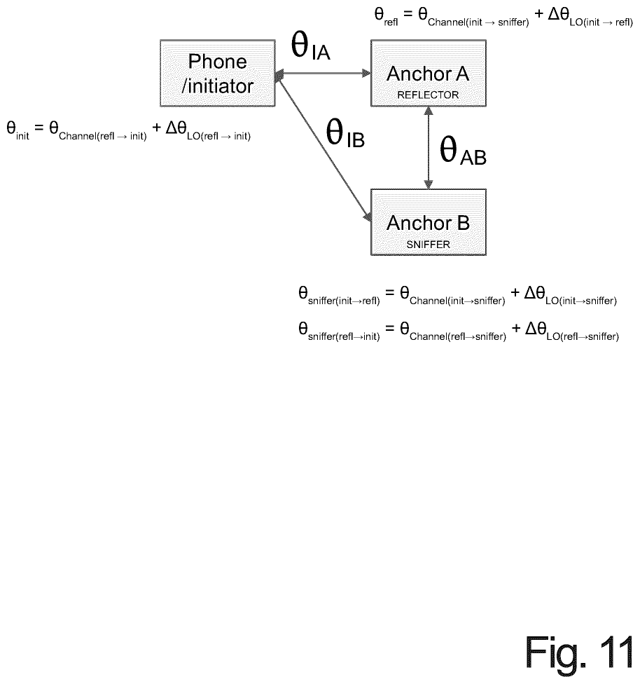

In FIG. 11, representative portion of the system 100 is shown with the remote device 20 and first and second object-based devices (e.g., an object device 50 or a sensor 40) arranged to communicate with the remote device 20. The object-based devices are designated anchor A and anchor B for purposes of discussion, and each of these devices may be a reflector in a phase-ranging analysis (e.g., a channel sounding range determination).

For each of the anchors A and B, a distance may be determined as a function a phase measurement for communications. As shown, theta IA and theta IB correspond respectively to the phase measurements for anchor A and anchor B. Based on these measurements, a theta AB between the anchor A and the anchor B can be determined, and a clock offset for the theta AB can be determined as well. Theta IA may correspond to the one-way phase rotation φ1ABmeasured described herein.

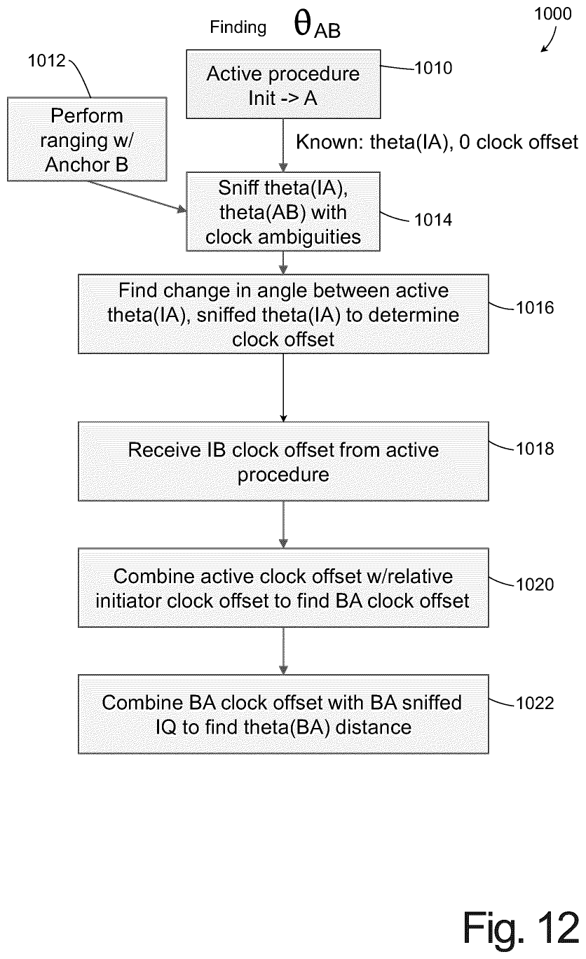

A method of determining a baseline theta AB is shown in FIG. 12 and generally designated 1000. The method 1000 includes conducting a phase ranging procedure between the remote device 20 and the anchor A. This phase ranging procedure may determine a theta IA, and establish a 0 clock offset reference. Step 1010. The method 1000 may initiate obtaining baseline values (e.g., a baseline clock offset between anchor B and the remote device 20). The method 1000 may be conducted at startup, such as when the system 100 is powered on.

The method 1000 may also include a phase ranging procedure conducted by the anchor B. Step 1012. Specifically, the anchor B may monitor the phase ranging procedure between the remote device 20 and the anchor A (e.g., sniffing a theta IA in anchor B). Based on the known theta IA and the sniffed theta IA as determined in anchor B by monitoring the phase ranging procedure between the remote device 20 and the anchor A, a theta AB with clock ambiguities can be determined. Step 1014.

The clock offset between anchor B (i.e., the sniffer) and the remote device 20 (i.e., the initiator) may be determined by aligning the known theta IA (determined as a phase ranging procedure between the anchor A and the remote device 20) with the sniffed theta IA (determined by the anchor B with respect to a phase ranging procedure between the anchor A and the remote device 20). The rotation required to align these two may correspond to relative clock offset between sniffing device (anchor B) and the initiator (the remote device 20). Step 1016.

When sniffing theta IA in anchor B, there is no direct information about theta AB. However, the relative clock offset between anchor A and anchor B can be derived by channel sounding IA and sniffing the remote device 20 and anchor A transmission (e.g., sniffing I and A transmissions). A comparison between a known offset for a channel sounding procedure between the remote device 20 and the anchor B may be compared with the derived clock offset between the anchor B and the remote device 20 in step 1016 to yield a relative clock offset for anchor B relative to anchor A.

The method 1000 may include receiving the clock offset between anchor B and the remote device 20. Step 1018. The method 1000 may also include combining an active clock offset with the relative offset between the anchor B and the remote device 20 to yield the clock offset between anchor B and anchor A. Step 1020.

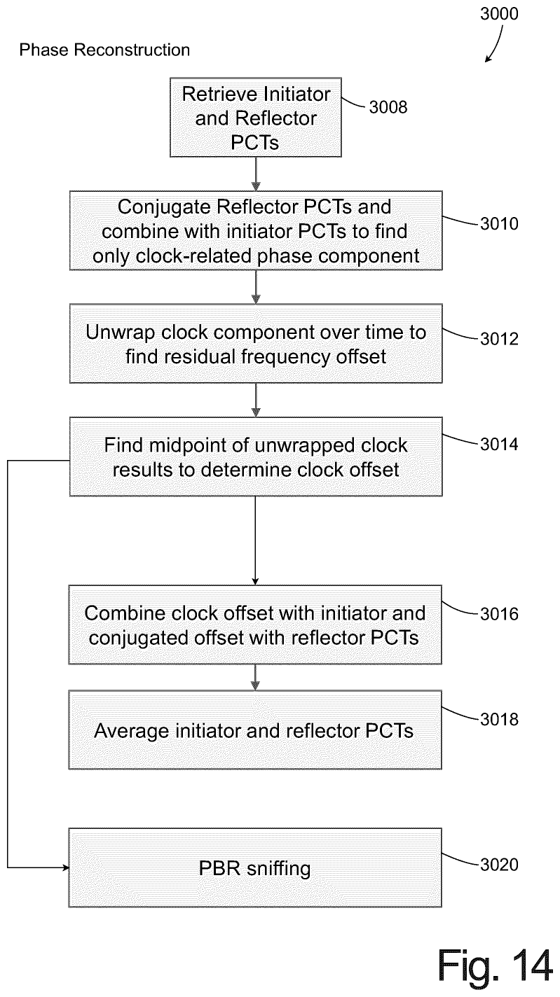

Based on 1) the clock offset determined between anchor B and anchor A at step 1020 and 2) the theta AB determined by anchor B by sniffing the channel sounding procedure between the remote device 20 and anchor A at step 1014, the theta AB distance without clock ambiguities relative to anchor A and anchor B can be determined by channel reconstruction. While many channel reconstruction methods have been contemplated, one embodiment is described below, i.e., step 3014 in FIG. 14. Step 1022.

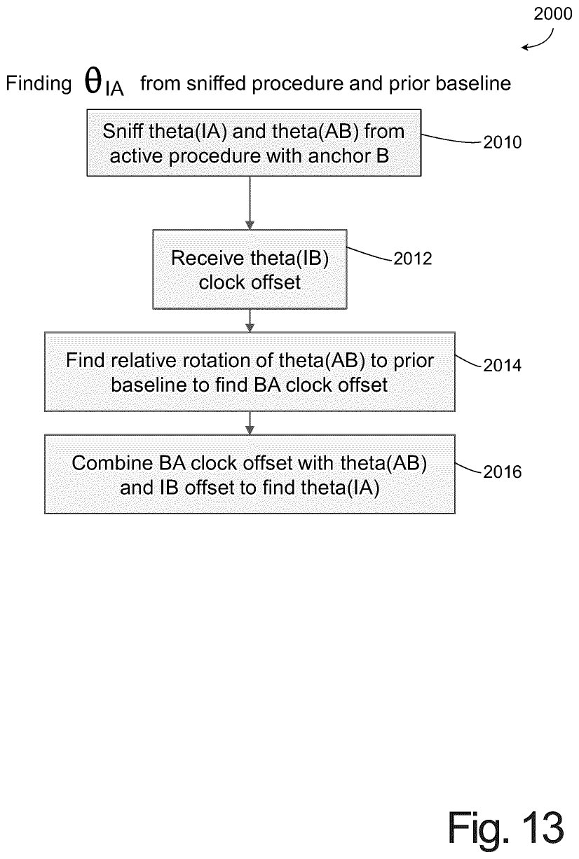

A method of determining theta AB from a sniffed procedure and a prior baseline is depicted in FIG. 13 and generally designated 2000. In this way, the baseline for theta AB determined in the method 1000 can be updated repeatedly, accounting for environment changes, motion of the remote device 20, and fading changes.

The method 2000 includes anchor B 1) sniffing theta IA for a phase ranging procedure between anchor A and the remote device 20 and 2) determining theta AB based on an active ranging procedure between anchor B and the remote device 20. Step 2010.

The method 2000 includes receiving a clock offset for theta IB. Step 2012.

The method 2000 includes determining relative rotation of theta AB to the prior baseline determination of theta AB determined in the method 1000 to determine the BA clock offset for the current procedure. Step 2014.

The method 2000 may include combining the BA clock offset with theta AB and

an IB offset to determine theta IA. Step 2016.

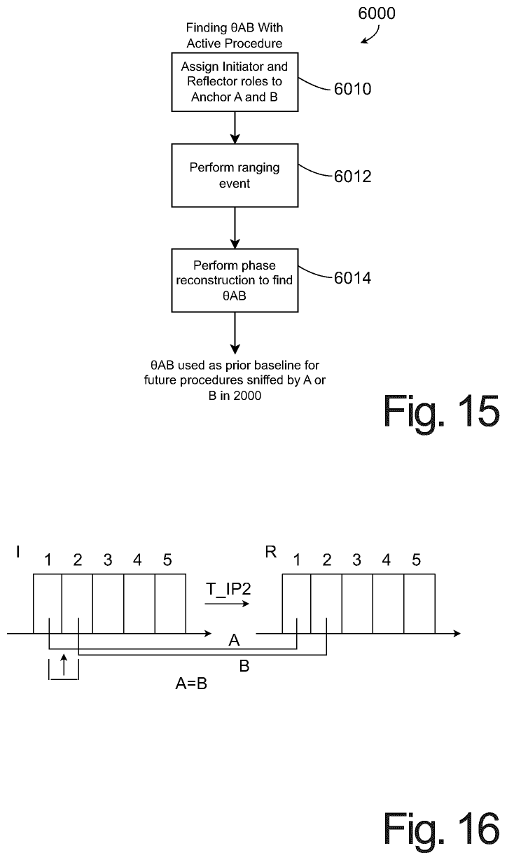

A method of determining theta AB in active manner between anchor A and anchor B is shown in FIG. 15 and generally designated 6000. The method 6000 includes assigning initiator and reflector rules respectively to the anchor A and anchor B devices. Step 6010. A phase ranging procedure may be conducted between the anchor A and anchor B devices. Step 6012. A phase reconstruction may be conducted based on the phase ranging procedure at step 6012 to determine theta AB between the anchor A and the anchor B. Step 6014. This theta AB may be used as a baseline for future ranging procedures and methods, including the methods involving sniffing in anchor A or anchor B a ranging procedure between the other of anchor A or anchor B and the remote device 20.

Passive sniffing according to the methods described herein may be achieved in a variety of ways. In one embodiment, the RF circuitry 204 of the object device 50 or the sensor 40 may be based on a Bluetooth radio, which, for example, is a Bluetooth Low Energy 5.3 compliant radio that supports multiple simultaneous secure connections. The RF circuitry 204 in this configuration may be configured to sniff the broadcasts of both the initiator (e.g., the remote device 20) and reflector (e.g., anchor A). Radio power-up/power-down/mode-change transitions may be sequenced in hardware. The timing for all or some of the signals may be reprogrammable, with separate signal high/low times available for both RX and TX sequences. In this way, the entries for TX control can be converted to RX block control lines with suitable timings and “TX” modes can be commanded to be RX instead.

This hardware adjustment to the RF circuitry 204 may introduce one or more limitations, with varying workarounds:

1. The controller may not drive several RX-related hardware control signals in TX mode. This may be overcome by switching the control signals manually using override registers available at the correct time during transitions.

2. There may not be overrides or control mechanisms to provide a correct reflector access address. To synchronize the sniffing anchor to the active anchor oscillator during sniffed procedures, the firmware may instead gather the T_FM tone of each mode-0 broadcast from the active anchor and compute a subsequent CFO value. This approach may have an added benefit of being more accurate than the hardware CFO estimation. The lack of access address controls may also present some limitations on leveraging the hardware for timing information in Mode 1 and Mode 3 steps.

There are also some firmware implementation changes that may be provided for the RF circuitry 204:
TQI calculation for sniffed tones/phases may not be implemented.

Data processing for the sniffing methodology described herein may be further explained according to the following definitions and formulas.

Beginning with some definitions for what the standard and sniffed PCTs are measuring:

$${θ}_{refl} = {θ}_{Channel ( init \to refl )} + {Δθ}_{LO ( init \to refl )}$$

$${θ}_{init} = {θ}_{Channel ( refl \to init )} + {Δθ}_{LO ( refl \to init )}$$

$${θ}_{sniffer ( init \to refl )} = {θ}_{Channel ( init \to sniffer )} + {Δθ}_{LO ( init \to sniffer )}$$

$${θ}_{sniffer ( refl \to init )} = {θ}_{Channel ( refl \to sniffer )} + {Δθ}_{LO ( refl \to sniffer )}$$

It is worth noting that the relationship of the LO phase difference can be considered as follows:

$${Δθ}_{LO ( refl \to init )} = - {Δθ}_{LO ( init \to refl )}$$

Assuming the propagation channel between initiator and reflector is symmetric i.e., (θ_{Channel(init→refl)}==θ_{Channel(refl→init)}), the following can be derived:

$$\begin{matrix}{θ}_{refl} + {θ}_{init} = {θ}_{Channel ( init \to refl )} + {θ}_{Channel ( refl \to init )} + \\ {Δθ}_{LO ( init \to refl )} + {Δθ}_{LO ( refl \to init )} \\ = 2 {θ}_{Channel ( init \to refl )}\end{matrix}$$

$$\begin{matrix}{θ}_{refl} - {θ}_{init} = {θ}_{Channel ( init \to refl )} - {θ}_{Channel ( refl \to init )} + \\ {Δθ}_{LO ( init \to refl )} - {Δθ}_{LO ( refl \to init )} \\ = 2 {Δθ}_{LO ( init \to refl )}\end{matrix}$$

The quantity 2θ_{Channel(init→refl)} may be useful for range estimation. After division by two, this quantity may represent the one-way phase of the channel for each tone, with a ±π phase ambiguity. The ambiguity in θ_{Channel(init→refl)} may be related to Δθ_{LO(init→refl)}, in that the opposite Fr ambiguity may be present for each tone.

Given the quantity Δθ_{LO(init→refl)} derived from the active initiator and reflector as well as the sniffed PCTs θ_{sniffer(init→refl)} and φ_{sniffer(init→sniffer)}, it is possible to solve for the phase information of interest in θ_{Channel(init→sniffer)}:

$${θ}_{sniffer ( init \to refl )} - {θ}_{sniffer ( refl \to init )} - {Δθ}_{LO ( init \to refl )} = {θ}_{Channel ( init \to sniffer )} + {Δθ}_{LO ( init \to sniffer )} - {θ}_{Channel ( refl \to sniffer )} - {Δθ}_{LO ( refl \to sniffer )} - {Δθ}_{LO ( init \to refl )}$$

Which simplifies to the following:

$${θ}_{sniffer ( init \to refl )} - {θ}_{sniffer ( refl \to init )} - {Δθ}_{LO ( init \to refl )} = {θ}_{Channel ( init \to sniffer )} - {θ}_{Channel ( refl \to sniffer )}$$

Based on this simplification, it is noted that by observing the phase of the initiator and reflector's tones and combining those observations with the information available from the active ranging devices, the per-channel difference between θ_{Channel(refl→sniffer)} and θ_{Channel(init→sniffer)}.

Round robin ranging procedures, θ_{Channel(init→sniffer)} can be measured directly when the “sniffer” anchor is the active anchor and compute θ_{Channel(refl→sniffer)}. Assuming the environment does not change, θ_{Channel(refl→sniffer)}, for a given active anchor is likely to be consistent, and θ_{Channel(init→sniffer)} can be computed on subsequent sniffed ranging procedures.

In one aspect, with information about the PLL state on both the active and sniffing anchor, the system 100 may determine and compensate for their relative phase for each frequency. The CFO measurement and compensation may be accurate and precise enough to reduce θ_{Channel(init→sniffer)} to a constant across a procedure within a reasonably small error term. This may make θ_{channel(init→sniffer)} interchangeable with θ_{LO(refl→init)}. As a result, θ_{Channel(init→sniffer)} may be computed directly by subtracting the θ_{LO(refl→init)} term that is obtainable from the active initiator and reflector.

$$\begin{matrix}{θ}_{sniffer ( init \to refl )} = {θ}_{Channel ( init \to sniffer )} + {Δθ}_{LO ( init \to sniffer )} \\ = {θ}_{Channel ( init \to sniffer )} + {Δθ}_{LO ( init \to refl )}\end{matrix}$$

A method of phase reconstruction is shown in FIG. 14 and generally designated 3000. The method may include retrieving initiator and reflector PCTs. Step 3008. These PCTs may correspond to the one-way PCTs described herein with clock ambiguities.

The method 3000 may include conjugating the reflector PCTs and combining with the initiator PCTs to determine the clock-related phase component. Step 3010. The clock component over time may be unwrapped to determine the residual frequency offset. Step 3012. The method 3000 may include identifying a midpoint of the unwrapped clock results to determine a clock offset, and combining the clock offset with initiator and conjugated offset with reflector PCs. Steps 3014, 3016.

The initiator and reflector PCTs may be averaged. Step 3018. The averaging procedure works to reduce noise in the measurements. While the averaging operation is contemplated, other noise reduction techniques may be used depending upon the implementation.

The method 3000 may also include PBR sniffing which is an input to the system and methods described above for determining ranges to passive anchors. For example, see step 1018 in FIG. 12. Step 3020.

Turning to FIG. 16, a visual aid is provided to facilitate understanding of recovery of the local oscillator offset.

### V. Motion Compensation

In one aspect, the system 100 may be configured with sniffing reflectors for measuring contemporaneous phase differences, and may be further configured to perform motion compensation to mitigate the deleterious effects of motion of the mobile device on the measured phase data. The method for performing motion compensation can counteract the effects that movement of the remote device 20 may impart on the measured phase information measured by the active and sniffing reflectors of the system 100. Each of the radios may measure phase information indicative of the range to the remote device 20.

The sniffed phase differences may include a nonlinear shift as a function of frequency (or Bluetooth channel) where the nonlinear shift may be indicative of the velocity of the mobile device coming directly towards or away from the sniffing reflector. A method of motion compensation may include comparing the nonlinear shifts in phase differences between the reflectors to determine and/or remove a velocity component in the measured data to improve ranging accuracy estimates.

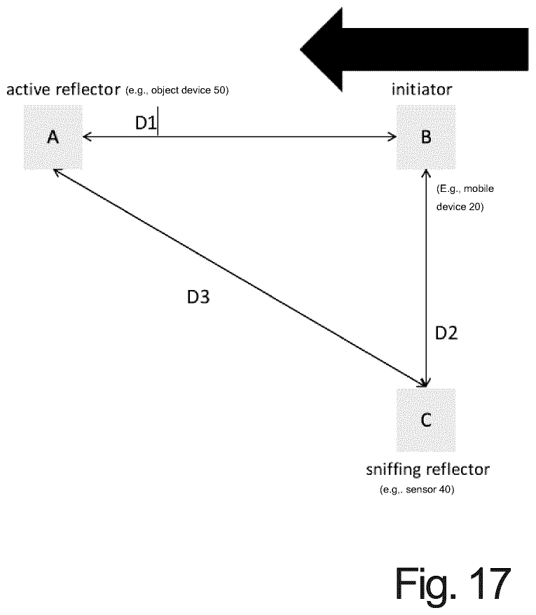

As depicted in FIG. 17, a portion of the system 100 is shown for discussion purposes with a reflector A, an initiator B, and a sniffing reflector B. The reflector A may correspond to an object device 50, the initiator B may correspond to a remote device 20, and the sniffing reflector C may correspond to a sensor 40. It is to be understood that the devices associated with reflector A, initiator B, and sniffing reflector B may vary depending on the application and circumstances.

In FIG. 17, the remote device 20 is moving toward the reflector A and tangent to sniffing reflector B. The phase D1 between the reflector A and the initiator B may include a “blueshift” effect due to the velocity of the initiator B moving toward the reflector A. The phase D2 between the initiator B and the sniffing reflector C may be observed as a linear response as the initiator B is moving tangentially with respect to the sniffing reflector C. The sniffed phase difference may provide an indication of the different observed velocities and a plurality of sniffing anchors may allow the system 100 to estimate a velocity vector based on the sniffed phase differences.

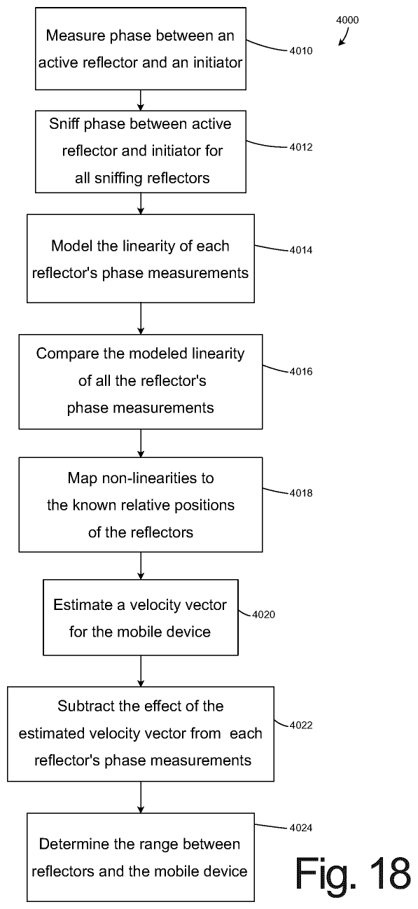

A method of motion compensation according to one aspect is shown in FIG. 18, and generally designated 4000. The method 4000 includes measuring the phase between an active reflector and an initiator. Step 4010. The method 4000 may then include sniffing the phase between the active reflector and the initiator for all sniffing reflectors (e.g., more than one sniffing reflector). Step 4012. The system 100 may model the linearity of each reflector's phase measurements, and compare the modeled linearity of all of the reflectors phase measurements. Steps 4014 and 4016.

The method 4000 may also include mapping the nonlinearities to the known relative positions of the sniffing reflectors. Step 4018. Estimations of a velocity vector may be determined for the remote device 20—e.g., the initiator B. Step 4020.

The method me include subtracting the effect of the estimated velocity vector from each reflectors phase measurements. Step 4022. The range between the reflectors and the mobile device may be determined based on the phase measurements and the subtracted effects. Step 4024.

### VI. Multi-Path Mitigation

In one aspect, a method may be provided for performing multipath mitigation to counteract the effects that a complex environment may have on the phase information measured by the reflectors of the system 100. The system 100 may be configured to perform a step of synthesizing a sparse two-dimensional aperture based on the contemporaneous phase information measured by the active reflector and the sniffing reflectors. The system 100 may be configured to perform a step to reconstruct a synthetic aperture image in and around an object 10 (e.g., a vehicle). The synthetic image may include two dimensional information relating to both real and multipath-induced sources. Algorithms for producing the image include filtered backprojection, interferometric imaging, FFT and CLEAN. Additionally, the system 100 may be configured to separate and remove the multipath-induced artifacts to better localize the remote device 20.

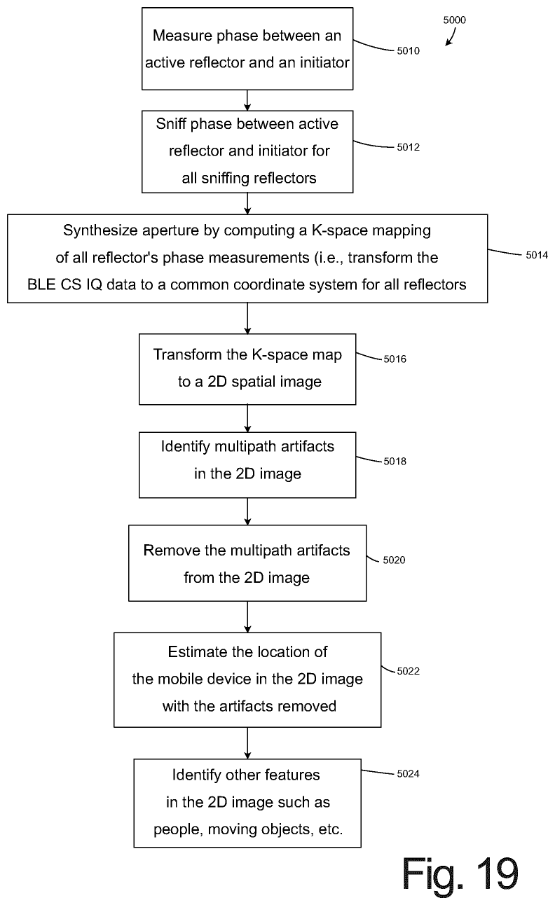

A method of multi path mitigation according to one aspect is shown in FIG. 19 and generally designated 5000. The method 5000 includes measuring the phase between an active reflector and an initiator. Step 5010. The method 5000 may then include sniffing the phase between the active reflector and the initiator for all sniffing reflectors (e.g., more than one sniffing reflector). Step 5012.

In one aspect to come by the method 5000 may include synthesizing an aperture by computing a K-space mapping of all reflectors phase measurements. This may include performing a transform of the radio IQ data (e.g., BLE CS IQ data) to a common coordinate system for all reflectors. Step 5014.

The method 5000 may include transforming the K-space map to a 2D spatial image, and identifying multipath artifacts in the 2D image. Steps 5016, 5018.

In one aspect, the method 5000 may include removing the multipath artifacts from the 2D image. Step 5020. The location of the mobile device may be estimated in the 2D image with the artifacts removed. Step 5022. The method 5000 may also include identifying other features in the 2D image, such as people or moving objects. Step 5024.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular. Any reference to claim elements as “at least one of X, Y and Z” is meant to include any one of X, Y or Z individually, and any combination of X, Y and Z, for example, X, Y, Z; X, Y; X, Z; and Y, Z.

1. A system for determining a distance between a remote device and an object, the system comprising:
a first device disposed in a fixed position relative to the object, the first device including a first antenna system configured to receive and/or transmit a first tone signal from and/or to the remote device;
a control system configured to determine a first phase characteristic and a second phase characteristic of the first tone signal at a first frequency and a second frequency, the first and second phase characteristics being indicative of a first phase rotation of the first tone signal between the first device and the remote device, the control system operable to determine a first distance between the first device and the remote device based on the first phase rotation of the first tone signal;
a second device disposed in a fixed position relative to the object, the second device including a second antenna system configured to monitor the first tone signal between the first device and the remote device; and
the control system configured to determine a second phase rotation of the first tone signal as monitored by the second device, the control system configured to determine a second device clock offset between the second device and the remote device based on the first phase rotation and the second phase rotation.

2. The system of claim 1 wherein the control system is configured to determine a relative clock offset between the first and second devices based on the second device clock offset.

3. The system of claim 2 wherein the control system is configured to determine a third phase rotation between the first and second devices without clock ambiguities based on the relative clock offset and an ambiguous phase rotation between the first and second devices determined based on the monitored first tone signal.

4. The system of claim 2 wherein:
the second device is configured to receive and/or transmit a second tone signal from and/or to the remote device;
the first device is configured to monitor the second tone signal between the second device and the remote device;
the control system is configured to determine a third phase rotation of the second tone signal between the second device and the remote device; and
the control system is configured to determine a fourth phase rotation between the remote device and the first device based on 1) the second tone signal as monitored by the first device and 2) the second device clock offset between the second device and the remote device.

5. The system of claim 1 wherein the first and second frequency are different.

6. The system of claim 1 wherein the control system is provided in the first device, and wherein the first device is operable as an initiator.

7. The system of claim 6 wherein the remote device is operable as a reflector.

8. The system of claim 6 wherein the control system is provided as first and second control systems separately disposed in the first and second devices.

9. The system of claim 1 wherein the remote device is operable as an initiator and the first device is operable as a reflector.

10. The system of claim 9 wherein the control system is operable to determine a third phase characteristic of the first tone signal at a third frequency, the third phase characteristic being indicative of the first phase rotation of the first tone signal between the first device and the remote device.

11. The system of claim 10, wherein the first, second, and third frequencies are different from each other.

12. The system of claim 1 wherein the first tone signal is an initiator tone signal, and wherein the first and second phase characteristics are determined by the remote device with respect to reception of the initiator tone signal from the first device.

13. The system of claim 1 wherein the first tone signal is a reflector tone signal, and wherein the first and second phase characteristics are determined by the first device with respect to reception of the reflector tone signal from the remote device.

14. The system of claim 13 wherein the first phase characteristic of the reflector tone signal is indicative of a two-way phase rotation of an initiator tone signal and the reflector tone signal at the first frequency, wherein the second phase characteristic of the reflector tone signal is indicative of a two-way phase rotation of the initiator tone signal and the reflector tone signal at the second frequency.

15. The system of claim 14 wherein the control system is operable to determine the first distance based on 1) a difference between the first phase characteristic and the second phase characteristic and 2) a difference between the first and second frequencies.

16. The system of claim 1 wherein the control system is configured to compensate for motion of the remote device relative to the first device.

17. The system of claim 16 wherein the control system is configured to subtract an effect of an estimated velocity vector from at least one of the first and second phase rotations.

18. The system of claim 1 wherein the control system is configured to compensate for multi-phase effects in an environment.

19. The system of claim 1 wherein the control system is configured to generate a K-space mapping of phase rotations and to identify multi-path artifacts based on the K-space mapping.

20. The system of claim 1 wherein the remote device is operable as a reflector and the first device is operable as an initiator.

21. The system of claim 1 wherein the second device is configured to receive and/or transmit a second tone signal from and/or to the first device.

22. The system of claim 21 wherein the control system is configured to determine a third phase characteristic based on the second tone signal.

23. The system of claim 22 wherein the control system is configured to repeatedly update the second device clock offset based on the second tone signal.

24. A method of determining a location of a remote device relative a first device, the method comprising:
transmitting an initiator signal between the remote device and the first device according to a first frequency;
transmitting the initiator signal between the remote device and the first device according to a second frequency;
determining a first phase characteristic of the initiator signal at the first frequency and a second phase characteristic of the initiator signal at the second frequency, wherein the first and second phase characteristics are indicative of a first phase rotation of the initiator signal between the first device and the remote device;
monitoring, in a second device, the initiator signal between the remote device and the first device;
determining a second phase rotation of the initiator signal as monitored by the second device;
determining a second device clock offset between the second device and the remote device based on the first phase rotation and the second phase rotation; and
determining the location of the remote device based at least on the first phase rotation.

25. The method of claim 24 comprising determining a relative clock offset between the first and second devices based on the second device clock offset.

26. The method of claim 25 comprising determining a third phase rotation between the first and second devices without clock ambiguities based on the relative clock offset and an ambiguous phase rotation between the first and second devices determined based on the monitored first tone signal.

27. The method of claim 24 comprising:
receiving and/or transmitting, relative to the second device, a second tone signal from and/or to the remote device;
monitoring, in the first device, the second tone signal between the second device and the remote device;
determining a third phase rotation of the second tone signal between the second device and the remote device; and
determining a fourth phase rotation between the remote device and the first device based on 1) the second tone signal as monitored by the first device and 2) the second device clock offset between the second device and the remote device.
